(19) United States
(12) Patent Application Publication
(10) Pub. No.: US 2025/0110246 A1
(43) Pub. Date: Apr. 3, 2025

(54) Methods and Apparatus for Controlling a Geiger-Müller Tube

(71) Applicant: Tracerco Limited, London (GB)

(72) Inventors: Philip Davies, Billingham (GB); Robert Holloway, Billingham (GB)

(73) Assignee: Tracerco Limited, London (GB)

(21) Appl. No.: 18/846,543

(22) PCT Filed: Dec. 6, 2022
(86) PCT No.: PCT/GB2022/053101

§ 371 Date: Sep. 12, 2024

(30) Foreign Application Priority Data
Mar. 15, 2022 (GB) 2203568.7

(51) Int. Cl. G01T 1/175; G01T 1/02; G01T 1/18

(52) U.S. Cl. CPC G01T 1/175; G01T 1/02; G01T 1/18

(57) ABSTRACT

A radiation detection apparatus (210) comprises a Geiger-Müller tube (220) comprising a chamber (222) equipped with an anode (230) and a cathode (240); a first connection configured to connect the anode (230) to an anode activation potential; and a second connection configured to connect the cathode (240) to a cathode activation potential, wherein the first connection comprises or consists of a permanent connection to a voltage supply (270). The apparatus comprises a transistor (281) configured to temporarily connect the cathode to its activation potential.

### FIELD

The present disclosure relates to methods and apparatus for controlling a Geiger-Müller tube. In particular, but not exclusively, the present invention relates to methods and apparatus for controlling and/or for measuring output from a Geiger-Müller tube.

### BACKGROUND

Radiation detection devices, e.g. radiation dosimeters, are a type of electronic device that measures the level of exposure (dose) to an external source of ionizing radiation. Radiation dosimeters are therefore typically used to monitor and/or record a dose and/or a dose rate of radiation in a given environment. This may be for continuous monitoring in a specific location. Alternatively, this may be for monitoring the potential exposure to ionising radiation by a person, in which case the dosimeter may typically be worn by the person being monitored. Such a device is commonly known as an electronic personal dosimeter. Electronic personal dosimeters typically provide a continuous readout of cumulative dose and/or instant dose rate and are often equipped with a warning element that can provide a user with a signal (such as an audible sound or a visual display) if a predetermined cumulative dose or dose rate is exceeded.

Electronic personal dosimeters are battery-powered, and typically use either a small Geiger-Müller (GM) tube or a semiconductor (Si chip) in which ionizing radiation releases charges result in measurable electric current. Examples of such devices include the Tracerco™ Personal Electronic Dosimeters.

A Geiger-Müller tube includes a chamber filled with a noble gas or halogen and a quench gas or vapour such as a hydrocarbon. The chamber is equipped with two electrodes that apply a potential difference of several hundred volts within the chamber. When an ionizing radiation hits the tube, the gas within the chamber is ionized by the incident radiation, which creates charged particles in the chamber. The electric field created by the voltage between the electrodes allows the created charge to move within the chamber, and the resulting electrical pulse is measured using electronics within the instrument.

A problem with radiation detectors using GM tubes is that, under application of a continuous voltage, after each ionising event, the tube takes a certain amount of time to charge up between pulses and be ready to count a subsequent event (as it is essentially a capacitor being charged via a large value resistor). This is commonly known as “dead time”. The actual dead time depends on several factors including the active volume and shape of the detector, making it difficult to correct for. This dead time can result in saturation of the GM tube, thus resulting in underreporting of the event rate, particularly in higher radiation environments.

Certain studies (see T. J. Lewis, GEIGER-COUNTER OPERATION WITHOUT DEAD-TIME, Appl. sci. Res., 1955, Section B, Vol 5, Queen Mary College, London) have suggested that it may be theoretically possible to switch a Geiger-Müller (GM) tube on and off in order to remove dead time effects and increase count rate measurement. This “time-to-count” approach is independent of dead time and limits the number of discharges in high radiation fields by introducing a fixed wait time between discharges, i.e., operating the counter with a pulsed voltage. The wait time is chosen to be longer than the recovery time of the tube. However, to date, no practical technical means of implementing this theoretical principle in an effective and reliable manner have been disclosed.

As mentioned above, in a Geiger-Müller tube, the GM tube includes a chamber filled with a halogen gas and quenching medium, and the chamber is equipped with two electrodes (an anode and a cathode) that apply a potential difference of several hundred volts within the chamber. Typically, in order to “charge” the tube, the voltage at the anode is increased to its target value (e.g. 550-600V). The cathode is typically at a 0V potential. The anode voltage is typically generated by passing a current through a very high value resistor at the anode, in order to prevent or limit the risk of arcing between the electrodes upon ionisation. However, there are a number of drawbacks associated with this conventional set-up. First, there is a “dead time” following an ionisation event (a discharge caused by incident radiation) which is a combination of two effects: (i) the time taken for the multiple electron avalanches to terminate; and (ii) it takes a finite amount of time for the tube to charge back up to its full voltage, due to the large current-limiting resistor at the anode, during which the probability of the GM Tube detecting radiation is reduced. Additionally, the voltage is typically applied continuously whilst the tube is charged until an ionizing event is detected, which is power-intensive at higher count rates.

It is an object of the present invention to address or mitigate one or more problems associated with the prior art.

### SUMMARY

The present inventors have developed a system and method configured to control a Geiger-Müller tube, which allows for an increased range of detection of a radiation detection device, i.e. capable of operating at very high radiation fields whilst retaining sensitivity for low count rates. The system of the present invention may offer one or more of the following advantages:
Faster activation of the GM tube
Lower risk of arcing
Mitigation of dead time
Ability to detect higher count rates
Increased range of detection
Lower power consumption
Reduced operating costs
Smaller size.

According to a first aspect of the present specification, there is provided a radiation detection apparatus, the radiation detection apparatus comprising:
a Geiger-Müller tube comprising a chamber equipped with two or more electrodes, wherein the chamber is configured to be charged by temporarily connecting the two or more electrodes to their respective activation potential.

The chamber may be provided with or may comprise a pair of electrodes, typically an anode and a cathode. The chamber may be configured to be charged by temporarily connecting the anode and the cathode to their respective activation potential. The activation potential of the anode may be in the range of about 300V-700V, e.g. about 440V-600V, typically about 550V. The activation potential of the cathode may be in the range of about 0V-50V, typically about 0V. The anode may be maintained at a constant electric potential, e.g. at the anode activation potential. The apparatus may further comprise a voltage supply unit configured to supply the anode activation potential.

Advantageously, the anode may not comprise or may not be coupled to a resistor. The anode activation potential may not be determined by or may not be defined by a resistor. It will be understood that, when the voltage supply unit supplying the activation potential to the anode comprises a resistor, such a resistor may have an ohmic value sufficiently low such that the activation potential supplied by the voltage supply unit is not determined or defined by the resistor when current load varies.

In conventional Geiger-Müller tubes, the anode voltage is typically generated by passing a current through a very high value resistor at the anode. This is generally required to minimise the risk of arcing between the electrodes upon ionisation. However, such an arrangement typically requires the voltage to be applied continuously whilst the GM tube is activated and until an ionizing event is detected, which is power-intensive and still carries some risk of arcing. In addition, a non-negligeable amount of time is required for the tube to charge back up to its full voltage, due to the large current-limiting resistor at the anode, which reduced the maximum count rate that the system can detect.

In the present arrangement, the chamber is configured to be charged by temporarily connecting the two or more electrodes, e.g. anode and cathode, of the chamber to their respective activation potential, and then disconnecting at least one of the electrodes, typically the cathode, from its activation potential, until an ionizing event occurs. The inventors have discovered that, by using the intrinsic capacitive properties of the GM tube, a temporary activation of the tube is sufficient to charge the tube and maintain the tube in a charged or activated state for a sufficient amount of time until an ionizing event occurs. This provides a number of advantages:
First, when the gas in the GM tube is ionized, the tube discharges instantly because no potential differential is actively applied at the moment when ionization occurs. Thus, the risk of arcing may be eliminated or at least greatly reduced. This may also result in a faster system that may be capable of detecting higher count rates.
Second, the power required to maintain the tube in a charged state may be reduced, particularly at high count rates. This is because, in the present system, the tube is charged at a predetermined time interval (typically 1 ms) following an ionisation event. Thus, at very high count rates, the number of times the tube can be charges will tend to 1000 times per second. In contrast, if powering the tube continuously, the maximum theoretical count rate would tend to 10⁶ times per second. Hence, the current required to keep the tube charged can be reduced by a factor up to 1000 in the present system.

The activation of the GM tube, e.g. connection of the cathode to its activation potential, may be performed for less than 1 ms, e.g. less than 100 μs, e.g. less than 10 μs, typically less than 5 μs. The activation of the GM tube may be performed for a period of about 10 ns-100 μs, e.g. about 100 ns-10 μs, typically about 500 ns-5 μs, e.g. between 500 ns and 2 μs. In an embodiment, the activation time may be about 1.2 μs. Thus, the activation time may be shorter than the/a typical or expected time-to-count value and/or may be shorter than a current pulse from the discharging of the tube.

The anode may be maintained at a constant electric potential, e.g. at its activation potential. The anode may be connected, e.g. permanently connected, to a voltage supply, e.g. via the voltage supply unit.

Advantageously, the cathode may be associated with a switch. The switch may be capable of connecting and disconnecting the cathode to its activating potential, e.g. about 0V. The switch may be provided within a cathode interface unit configured to activate and/or deactivate the cathode, e.g. configured to actuate the connection and disconnection of the cathode to its activation potential. The cathode switch may comprise or may be a transistor, preferably an N-type MOSFET (‘nFET’). Advantageously, this type of switch may provide a very fast means of activating the cathode, and thus of charging the GM tube. The apparatus may further comprise a controller, e.g. a microcontroller unit (MCU), configured to control the anode voltage supply and/or the cathode interface unit, e.g. the switch. Preferably, the controller may be configured to control the anode voltage supply and the cathode interface unit.

According to a second aspect of the present specification, there is provided a radiation detection apparatus, the radiation detection apparatus comprising:
a Geiger-Müller tube comprising a chamber equipped with an anode and a cathode;
a first connection configured to connect the anode to an anode activation potential; and
a second connection configured to connect the cathode to a cathode activation potential,
wherein the first connection comprises or consists of a permanent connection to a voltage supply.

The first connection may be provided within a voltage supply unit configured to supply the anode activation potential. Advantageously, the first connection may not comprise a resistor. The anode activation potential may not be determined by or may not be defined by a resistor. It will be understood that, when the voltage supply unit supplying the activation potential to the anode comprises a resistor, such a resistor may have an ohmic value sufficiently low such that the activation potential supplied by the voltage supply unit is not determined or defined by the resistor. This arrangement may allow for faster activation of the GM tube, lower risks of arcing, and/or shorter dead time.

The first connection may comprise or consist of a permanent connection to a voltage supply. The voltage supply may be maintained, e.g. continuously maintained, at the anode activation potential, during operation of the GM tube. The activation potential of the anode may be in the range of about 300V-700V, e.g. about 440V-600V, typically about 550V. The activation potential of the cathode may be in the range of about 0V-50V, typically about 0V.

The second connection may comprise a switch. The switch may be capable of connecting and disconnecting the cathode to the cathode activation potential. The cathode activation potential may be about 0V-50V, typically about 0V. The switch may be provided within a cathode interface unit configured to activate and/or deactivate the cathode, e.g. configured to actuate the connection and disconnection of the cathode to its activation potential. The switch may comprise or may be a transistor, preferably an N-type MOSFET (‘nFET’). Advantageously, this type of switch may provide a very fast means of activating the cathode, and thus of charging the G-M tube.

The provision of a switch in the second connection may allow the chamber to be charged by temporarily connecting the cathode of the chamber to its activation potential, e.g. by temporarily closing the switch. To activate or charge the GM tube, the switch may be closed for less than 1 ms, e.g. less than 100 μs, e.g. less than 10 μs, typically less than 5 μs. The activation of the GM tube may be performed by closing the switch for a period of about 10 ns-100 μs, e.g. about 100 ns-10 μs, typically about 500 ns-5 μs, e.g. between 500 ns and 2 μs. Thus, the activation time may be shorter than the/a typical or expected time-to-count value. In addition, the power required to maintain the potential differential between the electrodes may be reduced, even at high count rates.

The features described above in relation to the apparatus according to the first aspect are equally applicable in relation to the system according to the second aspect, and, merely for brevity, are not repeated here.

According to a third aspect of the present specification, there is provided a radiation detection apparatus, the radiation detection apparatus comprising:
a Geiger-Müller tube comprising a chamber equipped with an anode and a cathode;
a first connection configured to connect the anode to an anode activation potential; and
a second connection configured to connect the cathode to a cathode activation potential,
wherein the second connection comprises a switch.

The switch may be capable of connecting and disconnecting the cathode to its activation potential. The activation potential of the cathode may be in the range of about 0V-50V, typically about 0V. The switch may comprise or may be a transistor, preferably an N-type MOSFET (‘nFET’). Advantageously, this type of switch may provide a very fast means of activating the cathode, and thus of charging the G-M tube.

The provision of a switch in the second connection may allow the chamber to be charged by temporarily connecting the cathode to its activation potential, e.g. by temporarily closing the switch. To activate or charge the GM tube, the switch may be closed for less than 1 ms, e.g. less than 100 μs, e.g. less than 10 μs, typically less than 5 μs. The activation of the GM tube may be performed by closing the switch for a period of about 10 ns-100 μs, e.g. about 100 ns-10 μs, typically about 500 ns-5 μs, e.g. between 500 ns and 2 μs. Thus, the activation time may be shorter than the/a typical or expected time-to-count value. In addition, the power required to maintain the potential differential between the electrodes may be reduced, even at high count rates.

The first connection may comprise or may consist of a permanent connection to a voltage supply. The voltage supply may be maintained at the anode activation potential. The activation potential of the anode may be in the range of about 300V-700V, e.g. about 440V-600V, typically about 550V. The activation potential of the anode may be in the range of about 0V-50V, typically about 0V.

Advantageously, the first connection may not comprise a resistor. The anode activation potential may not be determined by or may not be defined by a resistor. It will be understood that, when the voltage supply unit supplying the activation potential to the anode comprises a resistor, such a resistor may have an ohmic value sufficiently low such that the activation potential supplied by the voltage supply unit is not determined or defined by the resistor. This arrangement may allow for faster activation of the GM tube, faster discharge upon ionization, lower risks of arcing, and/or shorter dead time.

The features described above in relation to the apparatus according to the first or second aspect are equally applicable in relation to the system according to the third aspect, and, merely for brevity, are not repeated here.

According to a fourth aspect, there is provided a method of activating a Geiger-Müller tube, wherein the Geiger-Müller tube comprises a chamber equipped with two or more electrodes,
wherein the method comprises charging the chamber by temporarily connecting the two or more electrodes to their respective activation potential.

The chamber may be provided with a pair of electrodes, typically an anode and a cathode. The method may comprise charging the chamber by temporarily connecting the anode and the cathode to their respective activation potential.

The method may comprise providing a first connection configured to connect the anode to its activation potential. The first connection may comprise or may consist of a permanent connection to a voltage supply. Advantageously, the first connection may not comprise a resistor. The anode activation potential may not be determined by or may not be defined by a resistor. It will be understood that, when the voltage supply unit supplying the activation potential to the anode comprises a resistor, such a resistor may have an ohmic value sufficiently low such that the activation potential supplied by the voltage supply unit is not determined or defined by the resistor. This arrangement may allow for faster activation of the G-M tube, faster discharge upon ionization, lower risks of arcing, and/or shorter dead time.

The method may comprise maintaining the voltage supply to the anode at the anode activation potential. The activation potential of the anode may be in the range of about 300V-700V, e.g. about 440V-600V, typically about 550V.

The method may comprise providing a second connection configured to connect the cathode to its activation potential. The activation potential of the cathode may be in the range of about 0V-50V, typically about 0V. The second connection may comprise a switch. The method may comprise charging the chamber by temporarily connecting the cathode to the chamber, e.g. by temporarily closing the switch. The switch may comprise or may be a transistor, preferably an N-type MOSFET (‘nFET’). Advantageously, this type of switch may provide a very fast means of activating the cathode, and thus of charging the G-M tube.

According to a fifth aspect of the present specification, there is provided a method of activating a Geiger-Müller tube, wherein the Geiger-Müller tube comprises a chamber equipped with an anode and a cathode; a first connection configured to connect the anode to an anode activation potential; and a second connection configured to connect the cathode a cathode activation potential,
wherein the method comprises charging the chamber by temporarily connecting the cathode to its activation potential.

Advantageously, the second connection may comprise a switch. The method may comprise charging the chamber by temporarily connecting the cathode to its activation potential by temporarily closing the switch. The activation potential of the cathode may be in the range of about 0V-50V, typically about 0V. The switch may comprise or may be a transistor, preferably an N-type MOSFET (‘nFET’). Advantageously, this type of switch may provide a very fast means of activating the cathode, and thus of charging the G-M tube.

According to a sixth aspect of the present specification, there is provided a controller for a radiation detection apparatus, the radiation detection apparatus comprising:
a Geiger-Müller tube comprising a chamber equipped with an anode and a cathode, wherein the chamber is configured to be charged by temporarily connecting the anode and the cathode to their respective activation potential;
a voltage supply unit configured to supply, e.g. continuously and/or permanently supply, the anode activation potential; and
a cathode interface unit configured to actuate the connection and/or disconnection of the cathode to its activation potential,
wherein the controller is configured to control actuation of the anode voltage supply unit and of the cathode interface unit.

The features described above in relation to the apparatus according to the first to third or sixth aspects are equally applicable in relation to the method according to the fourth or fifth aspects, and vice versa, and, merely for brevity, are not repeated here.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic diagram illustrating a radiation detection apparatus according to the prior art;

FIG. 2 illustrates the general principles of a “time-to-first-count” methodology;

FIGS. 3 to 5 show schematic diagrams illustrating a radiation detection apparatus according to an embodiment; and

FIG. 6 illustrates the principles of a “time-to-first-count” methodology implemented using the apparatus of FIGS. 3 to 5.

### DETAILED DESCRIPTION

As described in the summary section, the present specification provides systems and methods for controlling a Geiger-Müller tube, which allows for an increased range of detection of a radiation detection device, i.e. capable of operating at very high radiation fields whilst retaining sensitivity for low count rates. A number of more detailed examples are set out below to illustrate different embodiments of the present invention.

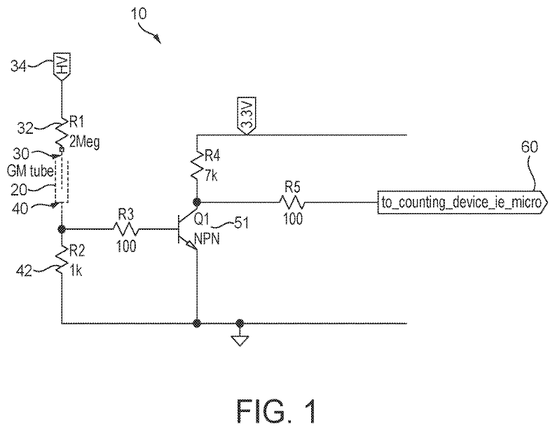

FIG. 1 shows a schematic diagram illustrating a radiation detection apparatus, generally designated 10, according to the prior art. The apparatus includes a GM tube 20 that includes a chamber filled with an inert gas and a quench gas or vapour. The chamber is equipped with two electrodes (an anode 30 and a cathode 40) that apply a potential difference of several hundred volts within the chamber.

In this arrangement, the high voltage 34 at the anode is typically generated by passing a current through a very high value resistor 32 at the anode 30. This is required to minimise the risk of arcing between the electrodes upon ionization in the GM tube 20. However, such an arrangement typically requires the voltage to be applied continuously whilst the GM tube 20 is activated and until an ionizing event is detected, which is power-intensive and still carries some risk of arcing. In addition, a non-negligeable amount of time is required for the tube to charge back up to its full voltage, due to the large current-limiting resistor 32 at the anode, which causes a “dead time” during which the GM tube cannot detect radiation. Resistor 32 typically has a large value to provide the above properties, in this example 2 MΩ.

At the cathode 40, resistor 42 will develop a voltage across it when current pulses flow through the GM tube, due to radiation, because Voltage =Current x Resistance. The brief pulse of voltage across resistor 42 will switch transistor 51 (or another amplifier element). This signal can then be connected to a counting device 60, such as a micro controller. By detecting the number of counts per second, the radiation “dose rate” can be calculated (Sieverts/Hour). The relationship between count rate and dose rate is approximately proportional.

As explained previously, a disadvantage of this method of operating the GM tube 20 is that it takes a finite time for the tube 20 to charge back up to 550V, due to the large current-limiting resistor 32. In addition, the gas in the GM tube 20 must have time to “quench” any free electrons prior to the next radiation event being detected. Such charging and quenching typically creates a “dead time” during which the GM tube 20 cannot detect radiation. This limits the maximum count rate that the detector can measure.

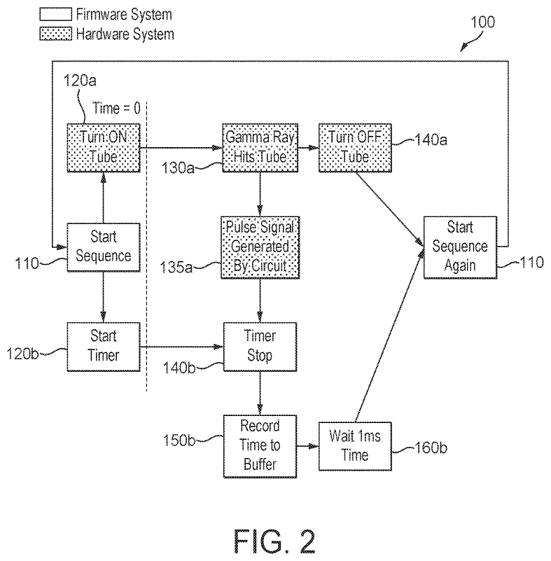

FIG. 2 illustrates the general principles of a “time-to-first-count” methodology. In such an approach, for example as suggested in T. J. Lewis (1955) discussed in the background section, a sequence is started 110 by simultaneously switching the GM tube on 120a and starting a timer 120b. In FIG. 2, the steps relating to hardware are provided with the suffix ‘a’ and the steps relating to firmware are provided with the suffix ‘b’.

An ionisation event occurs when an ionising radiation hits the GM tube 130a. This causes a pulse signal 135a to be generated within the circuit. This causes simultaneously the tube to be switched off 140a and the timer to stop 140b.

The time required to buffer the system is then recorded 150b and a period of time longer than the dead time associated with the tube (for example 1 ms) must then elapse 160b before the next sequence can be started again 110. In this example the wait time 160b is chosen to be 1 ms, but it will be appreciated that the wait time may be selected so as to allow the tube to fall back to ground state, for example between about 50 μs and about 700 μs.

However, as explained previously, a difficulty with the approach described in T. J. Lewis (1955) is that the tube takes a non-negligible amount of time to reach its full target potential when switched on at the beginning of each cycle, which can introduce a timing error. This renders the implementation of this technique difficult or impractical.

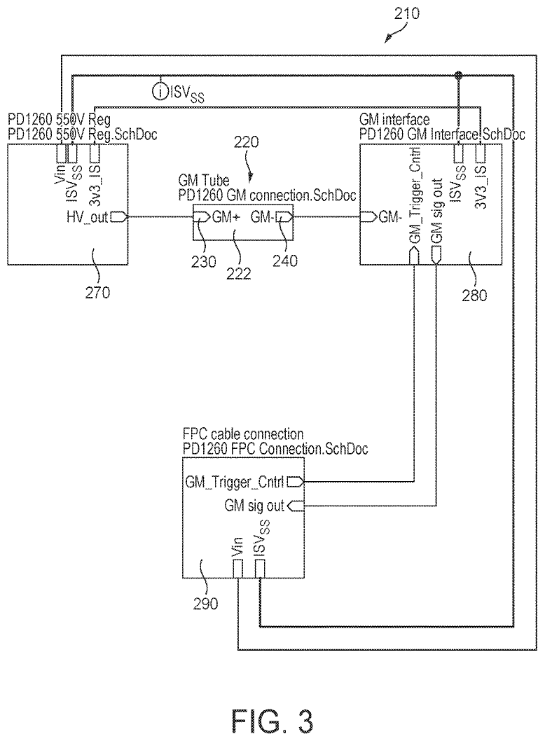

FIGS. 3 to 5 show schematic diagrams illustrating a radiation detection apparatus 210 according to an embodiment. Although significantly different, for ease of reference, the radiation detection apparatus 210 of FIG. 3 is generally similar to the radiation detection apparatus 10 of FIG. 1, like parts being denoted by like numerals, but incremented by ‘200’.

The radiation detection apparatus 210 includes a Geiger-Müller tube 220 comprising a chamber 222 equipped with an anode 230 and a cathode 240. In this embodiment, the GM tube circuit is designed for explosion-proof environments (Intrinsically Safe-referred to as “IS”) and non-IS applications.

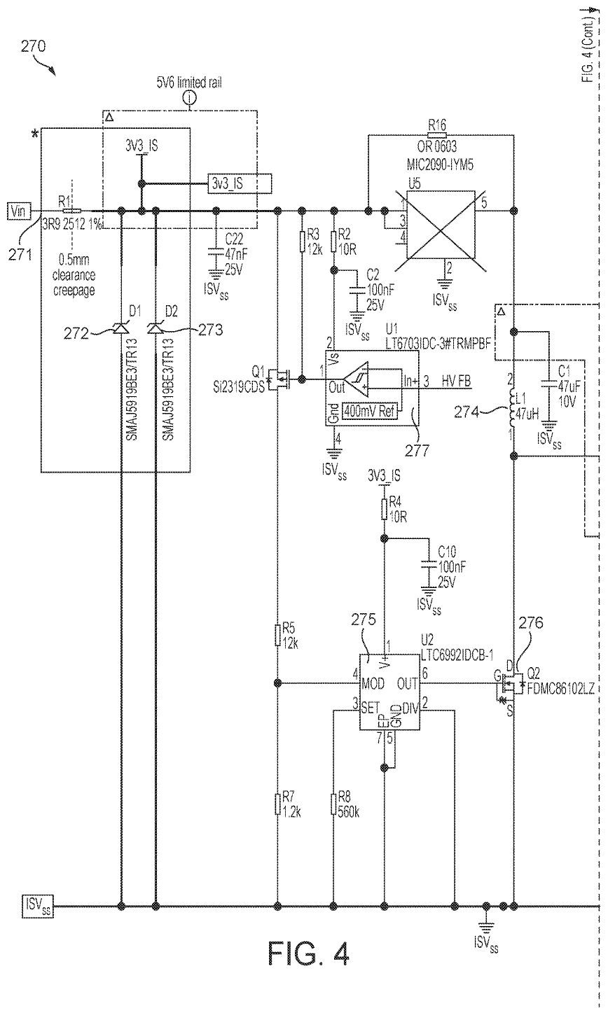

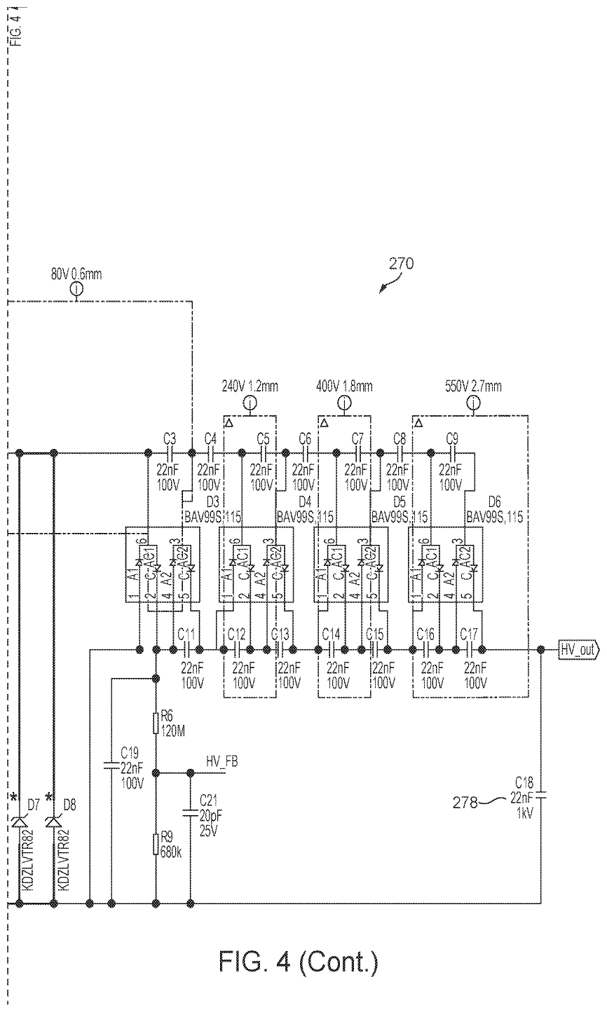

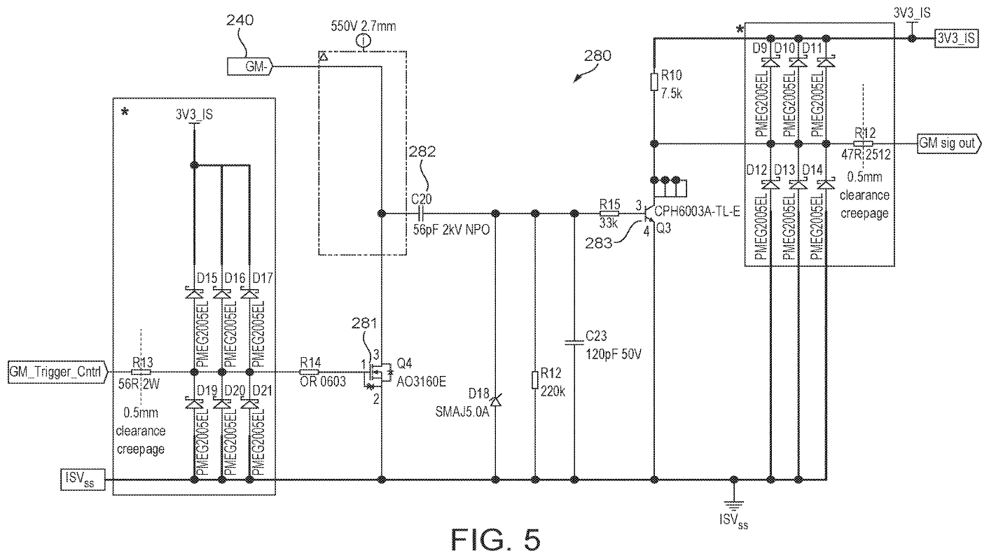

The anode 230 is powered by and is directed connected to a 550V supply unit 270 (described in more detail in FIG. 4) to place and/or maintain the anode in its activation potential. Thus, in contrast with the arrangement of FIG. 1, in the present arrangement, the anode 230 is not coupled to a resistor to provide the target activation potential, which may help reduce dead time. The cathode 240 is connected to an interface circuit 280 (described in more detail in FIG. 5). Both the supply unit 270 and the interface circuit 280 are connected to a Micro Controller Unit (MCU) 290, using pass-through current limiting connections to meet IS requirements.

For IS applications, the entire module apparatus 210 may be potted (encapsulated) for IS applications, including the GM tube 220. For convenience, in the event of GM tube failure, a portion of the apparatus 210, such as a housing portion or casing, can be discarded and replaced with a replacement GM tube potted module, as a single unit.

With reference to FIG. 4, the supply unit 270 has a small resistor 271 which is only used to limit spark ignition currents, whilst diodes 272,273 limit the voltage that could be fed back from the high voltage (HV) supply. This is present for IS protection. Although the supply unit 270 includes a resistor 271, it will be understood that the ohmic value of the resistor 271 is small (in this example 3.902) such that the voltage supplied by the unit 270 is not determined or defined by the resistor 271 (in contrast to a conventional system).

There is provided a switched inductor 274, which forms the basis of a boost regulator. Switched inductor 274 generates approx. 80V transients. Switching is controlled by controller 275, which drives transistor 276. Controller 275 runs at a set frequency, defined by the set resistor.

When the first stage of the charge pump reaches V>71 V, comparator 277 switches off the supply to the MOD pin of controller 275, preventing further switching. The effect is that controller 275 only runs in order to “top up” the HV supply.

In this example, seven charge pump stages are used to obtain 550V. Capacitor 278 holds the voltage for the GM tube and allows rapid recharging of the tube following an ionization event.

With reference to FIG. 5, the interface circuit 280 has a transistor 281 (Q4) which connects the GM tube cathode 240V to 0V. In this embodiment, the transistor 281 is an N-type MOSFET (‘nFET’). Advantageously, this type of transistor provides a very fast means of activating the cathode 240, and thus of charging the G-M tube 220.

Transistor 281 is normally OFF. Transistor 281 is switched on for 1.2 μs, though in practice it is only fully on for approximately 700 ns. This is enough time to charge the GM tube 220 to 550V. The GM 220 tube can be modelled as a 1.8 pF capacitor. Once charged, experiment shows that the tube 220 will retain its charge indefinitely, due to low leakage current through transistor 281, though the circuit is configured to recharge the tube 220 every 100 ms to ensure the GM tube 220 remains “primed”.

When an ionization event in the tube 220 occurs, the tube 220 discharges through capacitor 282 and biases transistor 283 (Q3) ON. This results in a short (less than 100 μs) active low pulse on the output of the circuit. When the pulse is detected, the MCU 290 waits for a predetermined period of time (in this embodiment 1 ms) to allow the tube 220 to quench. The MCU 290 then outputs the 1.2 μs signal to transistor 281 to restart the cycle of operation.

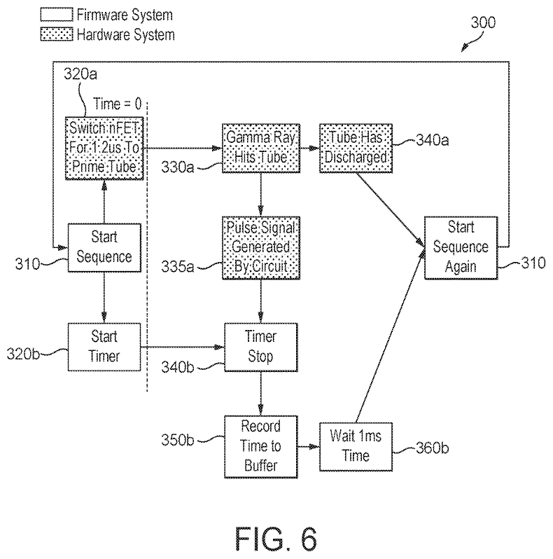

FIG. 6 illustrates the principles of a “time-to-first-count” methodology implemented using the apparatus of FIGS. 3 to 5. As in FIG. 2, the steps relating to hardware are provided with the suffix ‘a’ and the steps relating to firmware are provided with the suffix ‘b’.

In the present method, as explained above in detail, the GM tube is primed—charged to 550V—by connecting the cathode to 0V via an nFET for approximately 1.2 μs. Although in this example the “connection time” was 1.2 μs, it will be appreciated that the specific amount of time may be selected to be within a range that represents a very short time, i.e. that is less than the pulse width 360b.

In this embodiment, the sequence is started 310 by simultaneously priming the GM tube 320a and starting a timer 320b of the MCU 290. In other words, in this embodiment, the timer starts at the start of the recharge pulse. However, it will be appreciated that, in other embodiments, the counter may be started at the end of a recharge pulse. In other words, the timer start 320b may occur immediately at the end of the GM tube priming 320a.

An ionisation event occurs when an ionising radiation hits the GM tube 330a. This causes a pulse signal 335a to be generated within the circuit. This causes simultaneously the tube to be discharged instantly 340a and the timer to stop 340b. The time required to buffer the system is then recorded 350b and the next sequence is started again 310 after a pre-determined period of time selected for the apparatus 210 (for example 1 ms) (160b).

The present methodology and apparatus allows the implementation of a “time-to-first-count” approach, whilst addressing many of the associated disadvantages or limitations of the prior art.

1. A radiation detection apparatus, the radiation detection apparatus comprising:
a Geiger-Müller tube comprising a chamber equipped with two or more electrodes, comprising an anode and a cathode,
wherein the chamber is configured to be charged by temporarily connecting the anode and the cathode to their respective activation potential, wherein the cathode is configured to be temporarily connected to its activation potential as a result of detection of an ionizing event, and then disconnected from its activation potential, until a further ionizing event occurs.

2. (canceled)

3. A radiation detection apparatus according to claim 1, wherein the activation potential of the anode is about 550V, and wherein the activation potential of the cathode is about 0V.

4. A radiation detection apparatus according to claim 1, wherein the anode is maintained at a constant electric potential.

5. A radiation detection apparatus according to claim 1, wherein the apparatus comprises a voltage supply unit configured to supply the anode activation potential.

6. A radiation detection apparatus according to claim 5, wherein the anode activation potential is not determined by or is not defined by a resistor.

7. (canceled)

8. A radiation detection apparatus according to claim 1, wherein the cathode is associated with a switch, the switch being capable of connecting and disconnecting the cathode to its activating potential.

9. A radiation detection apparatus according to claim 8, wherein the cathode switch comprises a transistor, optionally an N-type MOSFET (‘nFET’).

10. A radiation detection apparatus according to any preceding claim 1, wherein the apparatus comprises a microcontroller unit (MCU) configured to control the anode voltage supply and/or the cathode switch.

11-12 (canceled)

13. A method of activating a Geiger-Müller tube, wherein the Geiger-Müller tube comprises a chamber equipped with two or more electrodes comprising an anode and a cathode,
wherein the method comprises charging the chamber by temporarily connecting the an anode and the cathode to their respective activation potential, wherein the cathode is temporarily connected to its activation potential as a result of detection of an ionizing event, and then disconnected from its activation potential, until a further ionizing event occurs.

14. A method according to claim 13, comprising providing a first connection configured to permanently connect the anode to its activation potential.

15. A method according to claim 13, the method comprising maintaining the voltage supply to the anode at the anode activation potential.

16. A method according to claim 13, comprising providing a second connection configured to connect the cathode to its activation potential.

17. A method according to claim 16, wherein the second connection comprises a switch.

18. A method according to claim 17, wherein the method comprises charging the chamber by temporarily connecting the cathode to its activation potential by temporarily closing the switch.

19. A method according to claim 17, wherein the switch comprises a transistor, optionally an N-type MOSFET (‘nFET’).

20. (canceled)

21. A controller for a radiation detection apparatus, the radiation detection apparatus comprising:
a Geiger-Müller tube comprising a chamber equipped with an anode and a cathode, wherein the chamber is configured to be charged by temporarily connecting the anode and the cathode to their respective activation potential;
a voltage supply unit configured to continuously and/or permanently supply the anode activation potential; and
a cathode interface unit configured to actuate the connection and/or disconnection of the cathode to its activation potential,
wherein the controller is configured to control actuation of the anode voltage supply unit and of the cathode interface unit, wherein controller is configured to temporarily connect the cathode to its activation potential as a result of detection of an ionizing event, and then disconnect the cathode from its activation potential, until a further ionizing event occurs.
